(19) United States
(12) Patent Application Publication
(10) Pub. No.: US 2026/0341571 A1
(43) Pub. Date: Oct. 29, 2026

(54) Coil Suitable for Use in an Inductive Device, a Method of Winding a Coil and an Inductive Device

(71) Applicant: ABB Schweiz AG, Baden (CH)

(72) Inventors: Wojciech Piasecki, Krakow (PL); Jedrzej Banaszczyk, Wieliczka (PL); Milos Gloc, Diváky (CZ); Lukas Belehrad, Namest nad Oslavou (CZ)

(73) Assignee: ABB Schweiz AG, Baden (CH)

(21) Appl. No.: 19/655,195

(22) Filed: Apr. 22, 2026

(30) Foreign Application Priority Data
Apr. 25, 2025 (EP) 25172719.4

(51) Int. Cl. H01F 27/00; H01F 27/28; H01F 27/32; H01F 41/064; H01F 30/06

(52) U.S. Cl. CPC H01F 27/006; H01F 27/2823; H01F 27/323; H01F 41/064; H01F 30/06

(57) ABSTRACT

A coil comprising at least two winding layers of a winding wire and at least two layers of dielectric material, each of the winding layers is placed on at least one layer of the dielectric material, each of the winding layers has a width smaller than the coil width, such that the winding layer occupies only a part of a coil surface. The winding layer comprises first and second ends, the first end forming a first edge of the coil, the second end ending between the first and second edges. The second end of the winding layer faces toward the second edge of the coil. At the second end, the winding wire extends toward the second edge of the coil and connects to the first end of a subsequent winding layer. The winding layers start alternately from opposite edges of the coil.

### CROSS-REFERENCE TO RELATED APPLICATIONS

The instant application claims priority to European Patent Application No. 25172719.4, filed Apr. 25, 2025, which is incorporated herein in its entirety by reference.

### FIELD OF THE DISCLOSURE

The present disclosure generally relates to a winding coil structure suitable for use in inductive devices such as voltage transformers or inductors, to a method of winding such coil, and to an inductive device comprising such coil.

### BACKGROUND OF THE INVENTION

Voltage transformers (VTs) are integral components in electrical systems, tasked with accurately stepping down high voltages to measurable levels for metering and protection purposes. A transformer structure comprises several key components, namely a core, a bobbin, primary and secondary winding and insulation. The core is typically made of laminated silicon steel sheets, which are stacked together to form a magnetic path. The core serves as the medium through which the magnetic flux travels, facilitating the efficient transfer of energy between windings. The primary winding is the coil that receives energy from an external source. In a transformer, the primary winding is connected to the input voltage source, and its alternating current creates a magnetic field. This magnetic field induces a voltage in the secondary winding placed adjacent to the primary winding, allowing energy transfer between circuits. The voltage induced in the secondary winding depends on the turns ratio between the primary and secondary windings. In medium voltage transformers that step down the voltage, the secondary winding has fewer turns of thicker wire compared to the primary winding, which has more turns of finer wire. This design allows the secondary winding to handle higher currents at lower voltages, while the primary winding handles lower currents at higher voltages. Insulating materials are used to electrically isolate the windings from each other and from the core, preventing short circuits and ensuring safe operation.

Inductors, one of which is a choke, are designed to block or “choke” high-frequency alternating current (AC) while allowing lower frequencies or direct current (DC) to pass. It's widely used in power supplies, filters, and radio-frequency (RF) circuits. A choke resists rapid changes in current by creating a magnetic field when current flows through it.

In the prior art, a standard structure of the coil for inductive devices, such as the primary coil for the medium voltage instrument transformer or the coil for choke, employs multiple layers of winding wires and an insulation material which are assembled in an alternate manner. Each layer is separated by insulating material to ensure dielectric withstand. The insulation usually has porous structure, and it is usually made e.g. from specialized insulating tapes, such as crepe paper or thermally upgraded kraft paper. Manufacturing of such coil starts with wrapping of few layers of the insulation material around a cylindrical bobbin. Further, a layer of the winding made of a thin wire is wrapped over the insulation layer. Subsequently several insulation and winding layers are wound one over another, and finally, the coil is impregnated with the epoxy resin under vacuum conditions and cured at elevated temperature.

This multilayer configuration results in densely packed turns of wire within each layer, leading to significant capacitive coupling between turns. The cumulative effect of these inter-turn capacitances, combined with the inductance inherent to the winding, establishes its natural or resonant frequency. The natural frequency (also referred to as self-resonant frequency, SRF, or main resonant frequency) of a winding coil is the frequency at which the coil resonates due to the interaction between its inductance and inherent capacitance. At frequencies below SRF, the coil primarily behaves as an inductor. At SRF, the inductive reactance and capacitive reactance cancel out, leading to a high-impedance point. At frequencies above SRF, the coil behaves more like a capacitor rather than an inductor. The natural frequency of the winding can be well approximated by the lumped capacitance and the lumped inductance values. The capacitance in such configurations can be approximated by modeling each layer as a cylindrical capacitor, i.e. the capacitance value can be calculated as a series connection of multiple cylindrical capacitors. Each layer of turns represents a cylinder and the two adjacent layers spaced by a thin insulation form a layer-layer capacitor. The layer-layer capacitance value is directly proportional to the surface area of the layer and inversely proportional to the distance between layers, dictated by the thickness of the insulating material. Consequently, as the number of layers (N) and the number of turns per layer (n) increase, the overall capacitance of the winding escalates. Simultaneously, the inductance of the coil is influenced by the total number of turns and the cross-sectional area of the coil, namely the equivalent inductance of the coil is proportional to the square of the numbers of turns and to cross section area of the coil. However, the inductance exhibits a complex relationship with the width of the layer; generally, an increase in layer width (where the width is measured between two farthest turns in the layer) results in a reduction in inductance.

For a coil with a very large number of turns, achieving low values of lumped inductance and capacitance becomes challenging. This difficulty leads to a lower resonant frequency of the winding, posing significant issues when the metrological parameters must be maintained well above the fundamental frequency. This concern is particularly pronounced when designing voltage transformers intended for power quality measurements that cover a frequency range up to or even above 20 kHz.

To address these challenges, various winding techniques have been explored. A known approach towards increasing the winding width involves the use of multiple strands of parallel wires to wind the primary coils. While this approach can reduce inductance, it concurrently increases capacitance due to the expanded surface area of the conductor (copper wiring layer), thereby even negating the benefits of inductance reduction.

Known approaches do not allow overcoming the challenges described above and have number of disadvantages. For instance, they do not allow to sufficiently minimize the self-inductance and self-capacitance of the multilayer primary winding.

### BRIEF SUMMARY OF THE INVENTION

The present disclosure describes systems and methods that overcome drawbacks of the prior art and address the limitations inherent in conventional winding designs by introducing an innovative winding configuration that optimally decreases inductance and capacitance. The present disclosure proposes a winding structure that maximizes the resonant frequency, ensuring accurate performance in high-frequency applications.

In one embodiment, the present disclosure describes a coil, which is suitable for use in an inductive device, the coil comprising: at least two winding layers of a winding wire, at least two layers of dielectric material, wherein each of the at least two winding layers is placed on a layer of the dielectric material, wherein each of the at least two winding layers has a width smaller than the coil width, such that the winding layer occupies only a part of a coil surface, wherein the winding layer comprises a first end and a second end, wherein the first end of the winding layer is essentially a first edge of the coil, and the second end of the winding layer ends between the first edge and a second edge of the coil and wherein the second end of the winding layer faces toward the second edge of the coil, wherein at the second end of the winding layer, the winding wire extends toward the second edge of the coil and connects to the first end of the subsequent winding layer; and wherein the winding layers start alternately from the opposite edges of the coil.

### BRIEF DESCRIPTION OF THE SEVERAL VIEWS OF THE DRAWINGS

FIG. 1 is a graph showing the dependence of the coil inductance from the width of the coil, in accordance with the disclosure.

FIG. 2 is an exemplary the cross-section of coil winding layers according to the first embodiment of the present disclosure.

FIG. 3 is a cross-section of coil winding layers according to the second embodiment of the present disclosure, in which a gap between the winding layers is filled with dielectric material.

FIG. 4 is a cross-section of coil winding layers according to a third embodiment, in which gaps between the winding layers are empty, in accordance with the disclosure.

FIG. 5 is a cross-section of coil winding layers, in which subsequent winding layers have uneven number of turns, in accordance with the disclosure.

FIG. 6 is a cross-section of coil winding layers in which the winding layers have an uneven number of turns and form a trapezoidal shape, in accordance with the disclosure.

FIG. 7 is a schematic view in cross section of a transformer comprising a coil in accordance with the disclosure.

FIG. 8 is a graph of a comparison of error curves for a standard VT winding and a winding in accordance with the disclosure.

### DETAILED DESCRIPTION OF THE INVENTION

In general, inductance of a coil depends on the total number of turns and the cross-sectional area of the coil. The inductance exhibits a complex relationship with the width of the winding layer. In general, the increase in layer width results in inductance reduction. However, as the number of layers and the number of turns per layer increase, the overall capacitance of the winding rises due to the expanded surface area of the winding.

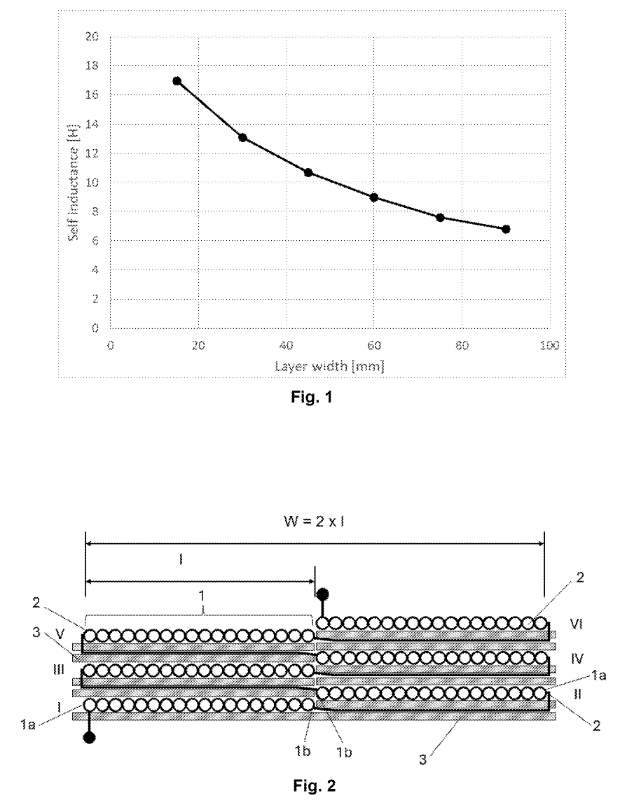

FIG. 1 shows the dependence of the calculated coil inductance from the width of the coil’s layers. The width is measured between two farthermost turns, i.e. between the opposite edges of the coil. For the purpose of obtaining the results depicted in FIG. 1, number of layers was fixed to 100, the number of turns was fixed to 1000, the diameter of the bobbin was fixed to 70 mm, the thickness of the dielectric insulation material was fixed to 0,12 mm, and the diameter of the winding wire was fixed to 0,25 mm. The width of the coil was increased (up to 90 mm) by increased pitch, achieved by loose winding and/or by use of insulating spacers.

Assume that the reference, standard winding design of a voltage transformer comprises N layers, each separated by a dielectric material having thickness t. Each winding layer comprises n turns of winding wire, where the wire itself has a thickness d. The cumulative width of each winding layer, denoted as l, is determined by the number of turns n and the wire thickness d, expressed as: l = n x d. The total radial build of the winding R, referred to as the radial width or diameter of the coil, encompasses the combined thicknesses of all layers and the insulating materials. This total radial width can be expressed as: R = N x (d + t). The inductance of the coil having given total number of turns (n x N) is significantly influenced by the width of the winding layers, as depicted in FIG. 1. As can be seen, an increase in the layer width leads to a reduction in inductance. This inverse relationship arises because a wider coil spreads the magnetic field over a larger volume, thereby reducing the magnetic coupling between turns and consequently lowering the inductance.

Therefore, to achieve a lower inductance in the VT winding, it is advantageous to increase the winding's width. To achieve simultaneously lower inductance and lower capacitance, it is advantageous to increase the winding's width without excessively increasing the total surface of the winding.

The present invention, in general, proposes a coil winding which may be described as segmented or sectional. The present approach divides the winding into multiple sections, with insulation between each section. As a result, the width of the individual winding layer is significantly smaller than the width of the coil. Therefore, it has fewer turns in comparison to a standard coil having the same width. By reducing the number of turns per section and increasing the physical separation between turns, this method decreases inter-turn capacitance. The present invention thus allows to maximize the self-resonance frequency of the winding by decreasing both the inductance and the capacitance.

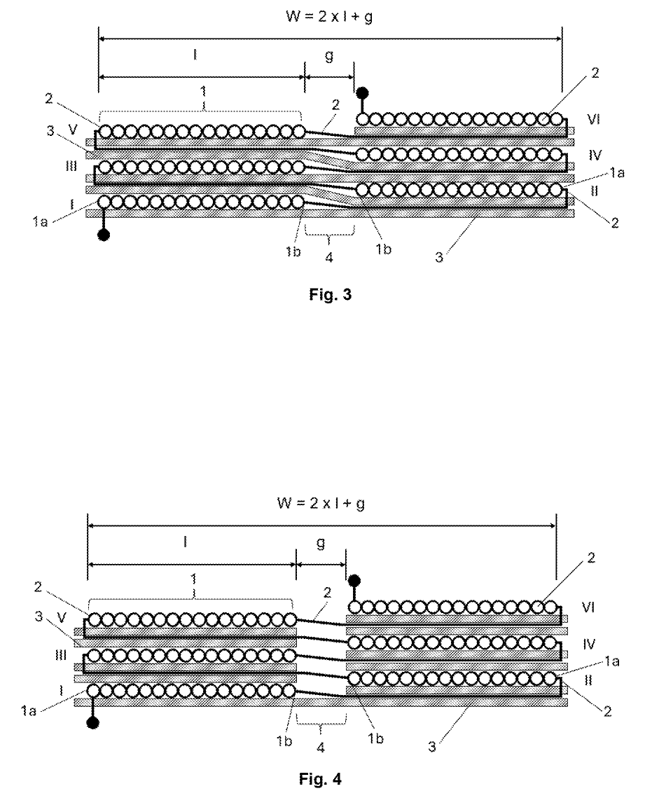

This has been achieved by splitting the winding layers into alternating partial layers, for example half layers, as shown in FIGS. 2-6. Each partial winding layer 1 occupies only a part of the coil width W, where the width is measured from one edge of the coil to the other edge of the coil, i.e. between two farthermost turns of the adjacent partial winding layers 1. In other words, the individual winding layer 1 does not surround the coil from its one edge to its opposite edge, but it starts from the one edge and reaches only part of the width of the coil. For example, it reaches at most half of the width W of the coil an thus it is split at most halfway through this width W, as shown in FIGS. 2 and 3, however the ratio of the width W of the coil to the width of the winding layer 1 may be different. Each winding layer 1 comprises n turns of winding wire 2. At the level of a single winding layer 1, one part of the coil’s width W thus comprises a winding having n turns, and the other part of the coil’s width W comprises a section of winding wire 2 which only partially encircles the coil, and reaches to its opposite edge, preferably without making a full turn around the coil (for example ¼ turn or even straight to the edge of the coil). However, the opposite edge of the winding (of the coil) can be reached by making a single or a few turns. The winding wire 2 is typically made from copper, but it is known that the wire 2 can be made from any metal and alloys or that the wire 2 can be replaced with any conductor suitable for winding. The winding wire 2 ends with a terminal on each end which connects the windings, wherein the terminal is placed such that it may be connected to, and each (inner) layer of the winding wire 2 is placed between two layers of a dielectric material 3. In other words, one of the winding layers 1 is located on a first level, and another one of the winding layers 1 is located on a second level, divided by dielectric material 3.

The winding layer 1 in each embodiment comprises a first end 1a and a second end 1b, wherein the first end 1a of the winding layer 1 is essentially a first edge of the coil, and the second end 1b of the winding layer 1 ends between the first edge and a second edge of the coil. The second end 1b of the winding layer 1 is facing toward the second edge of the coil. Therefore, each of the partial winding layers 1 starts from the edge of the coil and continues towards the center of the coil. At that point the winding is paused and the winding wire 2 is drawn to the opposite edge of the coil (at the level of that winding layer). In other words, the winding wire 2 extends toward the second end of the coil and connects to the first end 1a of the next winding layer 1. For example, the winding wire 2 is conducted to the opposite edge as a quarter of one turn. Therefore, the remaining part of the width W of the coil, through which the segment of the wire 2 is drawn to the opposite edge of the coil, does not comprise winding layer 1. This remaining part is filled by the dielectric material 3. This dielectric filling material 3 may have thickness similar to the winding wire 2 diameter, for example the same thickness, so both parts of an overall layer have similar thickness. More preferably, the dielectric material 3 has smaller thickness than the diameter of the winding wire 2. In one example, the winding wire 2 may have a thickness of 0,25 mm, while the layer of dielectric material 3 may have a thickness of 0,1 mm. Here, the overall layer comprises the part of winding layer 1 and the part comprising the winding wire 2 reaching to the end of the coil. The dielectric material 3 is placed also below the first (I) partial winding layer 1, closest to the coil’s bobbin – thus, the innermost winding layer 1 is placed on top of the layer of dielectric material 3. In all embodiments, each of inner winding layers 1 is placed between two layers of the dielectric material 3, while the outermost winding layer 1 may be covered with dielectric material 3 or not. Therefore, each winding layer 1 is placed on at least one layer of dielectric material 3. Thereby, a sandwich arrangement is formed in which the inner winding layers 1 are also covered by the dielectric material 3 from above, while the last (outermost) winding layer 1 may also be covered with dielectric material 3 or may remain uncovered. In FIGS. 2-6, the outermost winding layer 1 is not covered by the dielectric material 3. Obviously, in all embodiments, the outermost winding layer 1 may end at it second end 1b, without the winding wire 2 being drawn to the opposite edge of the coil, as shown in FIGS. 2-6. Alternatively, the winding wire 2 may be drawn to the opposite edge of the coil or to a certain point at its surface.

The first embodiment of the present invention is depicted in FIG. 2. FIG. 2 shows the cross-section through the winding of the coil, where each partial winding layer 1 comprises n turns of the winding wire 2. The coil comprises N partial winding layers 1, arranged alternately, for example 100 layers. For the sake of clarity, FIG. 2 shows only six winding layers 1, numbered as I, II, III, IV, V, VI. Each partial winding layer 1, for example first winding layer (I), starts from its first end 1a which is essentially the edge of the coil, and continues toward its centre. Therefore, in the embodiment shown in FIG. 2, the winding wire 2 makes turns around the coil substantially up to the centre of the coil. In this embodiment, each winding layer 1 is therefore paused at the centre of the coil. Therefore, the width of the partial winding layer 1, i.e. the width of the winding in each winding layer 1, is substantially half of the coil width W. When said second end 1b of the partial winding layer 1 is reached, the wire 2 is conducted to the opposite edge of the coil. The entire overall layer includes both the part comprising winding layer 1 and the remaining part of the winding wire 2 conducted to the opposite of the coil. The winding layer 1 and the remaining part comprising the winding wire 2 conducted to the opposite edge of the coil are covered with the dielectric material 3. In other words, the entire surface of the coil is covered with dielectric material 3. Then, the winding of the next layer (II) starts from this opposite edge of the coil, from its first end 1a. When the winding layer 1 of the second layer (II) reaches its end 1b, the wire 2 is conducted from the second end 1b to the previous (first) edge of the coil. Again, the entire surface of the coil, i.e. both the winding layer 1 and the part which comprises only the segment of the wire 2 conducted to the edge, is covered with the dielectric material 3. The process continues until the required number of partial winding layers 1, comprising required total number of turns n, is reached. As a result, the entire coil width W comprises two interlinked sections of winding. In each layer, one part has a winding and the other part lacks winding but comprises the winding wire 2 conducted to the edge of the coil. To avoid creating a bulge on the coil, the first winding layer 1 (I) should not overlap with the following second winding layer 1 (II), the third winding layer 1 (III) should not overlap with the following fourth winding layer 1 (IV), etc. In the first embodiment, the winding layers 1 have the same width. Therefore, the width W of the coil equals substantially two times the width of the winding layer 1 (l), with a possible small setoff resulting from the setoff of the dielectric material 3 and/or setoff resulting from loose winding and/or use of insulating spacers: W ≈ 2 x n x d ≈ 2 x l).

Second embodiment of the invention is depicted in FIG. 3. FIG. 3 also shows the cross-section through the winding of the coil, where each partial winding layer 1 comprises n turns of the winding wire 2. The coil comprises N partial winding layers 1, arranged alternately, for example 100 layers. For the sake of clarity, FIG. 3 shows only six winding layers 1, numbered as I, II, III, IV, V, VI. Each partial winding layer 1, having similarly a first end 1a and a second end 1b, for example first winding layer (I), starts from the winding edge which is the edge of the coil and continues toward its centre. However, in this embodiment the winding of each winding layer 1 does not reach the centre of the coil. In contrary to the first embodiment, the width of the partial layer 1, i.e. the width of the winding in each winding layer 1, is smaller than half of the coil width W. This results in a formation of a gap 4 between the alternating partial winding layers 1. The gap 4 is defined by the distance between the closest turns (second ends 1b) of the adjacent winding layers 1 (I and II, II and III, III and IV, IV and V, etc.). In this gap 4 electric field is present. When said end of the partial winding layer 1 is reached, said end being provided before reaching the center of the coil, the winding wire 2 is conducted to the opposite edge of the coil. The entire overall layer includes thus both the part comprising winding layer 1 and the remaining part of the wire 2 conducted to the opposite edge of the coil.

In the embodiment depicted in FIG. 3, the winding layer 1 and the remaining part comprising the winding wire 2 conducted to the opposite edge of the coil are covered with the dielectric material 3. The dielectric material 3 thus covers the whole width of the coil, i.e. the entire surface of the coil.

In an alternative embodiment, shown in FIG. 4, the dielectric material 3 covers only the area occupied by winding layers 1. In such case only the area above and below the winding layers 1 is covered, such that a segment of the non-winded wire 2 remains unfilled with the dielectric material 3, thereby leaving the gap 4 between the partial winding layers 1 empty. In FIG. 4, the gap 4 is located in the center area of the coil. Similarly, as in the first embodiment, the next winding layer 1 (II) following the previous winding layer 1 (I) starts from the opposite edge of the coil. When the winding of the second winding layer 1 (II) reaches the required point (in embodiment depicted in FIG. 4 - well before reaching the centre of the coil), the winding wire 2 is conducted to the previous (first) edge of the coil. Again, the surface of the coil, i.e. both the winding and the part which comprises only the segment of the wire 2 conducted to the edge, is covered with the dielectric material 3. The process continues until the required number of partial winding layers 1, comprising required total number of turns n, is reached. As a result, the entire coil width W comprises two interlinked sections of winding layers 1 with a gap 4 between them. In this embodiment, similarly, the width of the coil equals two times the width of the winding (l) plus the width of the gap 4 (g): W ≈ 2 x n x d + g ≈ 2 x l + g).

To sum up, one of the winding layer 1 (I) and the remaining part of the winding wire 2, conducted to the side of the coil, are placed between the first layer and the second layer of the dielectric material 3, another one of the winding layer 1 (II) and the remaining part of the winding wire 2 are placed between the second layer and the third layer of the dielectric material, and another one of the winding layer 1 (III) and the remaining part of the winding wire 2 are placed between the third layer and the fourth layer of the dielectric material 3, etc. The layers of dielectric material 3 includes gaps 4, which may be filled by the dielectric material 3 or not.

In another embodiments the number of turns n in partial winding layers 1 (layers lying on top of each other or oppositely arranged layers) is not equal, and thus the ratio of the number of layers n in adjacent winding layers 1 is not 50/50 as shown in FIGS. 2, 3 and 4.

One of such embodiments is shown in FIG. 5. Here, one winding layer 1 (I) reaches beyond the centre of the coil, and the following winding layer 1 (II) does not reach the centre of the coil. Therefore, the winding layers 1 (e.g. I, III) placed at one side of the coil have greater width (l1) than the winding layers 1 (e.g. II, IV) placed at the opposite side (l2). The dielectric material 3 is provided between the winding layers 1 analogously as for the previous embodiments. In FIG. 5 the ratio of the number of turns n between the adjacent winding layers 1 (I and II; III and IV; etc.) is 9:8. In such a case the gap 4 may also be provided and may be filled by the dielectric material 3 or not. In another variant, neither of the winding layers 1 reaches the centre of the coil, whereby the adjacent (opposite) winding layers 1 have different number of turns.

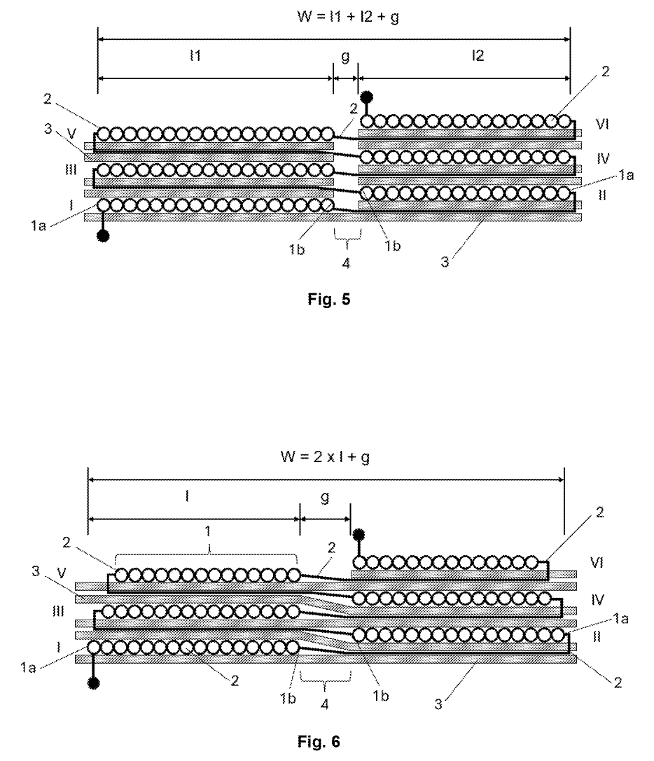

Another embodiment, where the number of turns n in alternating partial winding layers 1 is not equal, is shown in FIG. 6. In this case the consecutive sublayers, meaning the winding layers 1 placed one over another (I and III; II and IV; etc.) do not have equal number of turns n. In this case the coil may have another shape than square, for example trapezoidal shape, as shown in FIG. 6. Here, the winding layer 1 (I) has more turns than winding layer 1 (III), and the winding layer 1 (II) has more turns than winding layer 1 (IV), etc. Trapezoidal shape is achieved by decreasing number of turns in the winding layers 1 arranged on top of each other. In such a case, the gap 4 is provided and may be filled by the dielectric material 3 or not.

As the distance between the adjacent winding layers 1 is increased, the distance being determined by the width of the gap 4 between them, the width of the entire coil W may also be increased (while maintaining the same number of turns n is possible). This allows for further decrease of the capacitance.

The additional benefit of the gap 4 is that during the casting process the epoxy fills the gap 4 between the sections, reducing risk of potential voids and better impregnating all edges of the winding. Additionally, leaving the gap 4 empty (without the dielectric material 3) further facilitates filling with epoxy.

In case where the coil comprises a gap 4, it may have for example the width similar to the diameter of the winding wire 2. There is no upper limit of the width of the gap 4. Greater width of the gap 4 allows for further increase of the coil’s width. For example, the gap may be even 50 mm wide or more.

The diameter of the bobbin is for example from 20 mm to 350 mm. The width of the winding wire 2 is for example from 0,1 mm to 1 mm. The dielectric material is for example PET foil (Mylar), Trivolton, Paper, PTFE. The number of turns n in the winding layer 1 is for example from 100 to 500. The thickness of the dielectric material 3 is for example from 0,05 mm to,0.3 mm. The number of dielectric layers 3 placed under or on top of the winding layer 1 is at least one, but may be more, for example two or three layers of dielectric material 3. The bobbin of the coil may be of various shapes, as its shape does not affect the functioning of the invention – for this reason the Figures do not depict the bobbin. The bobbin may for example be cylindrical, toroidal, elliptical, rectangular or have another polygonal shape.

Another aspect of the present disclosure is a method of winding a coil resulting in providing the winding design described in, but not limited to, the embodiments above. The method comprises the steps of winding a layer of winding wire 2 on a dielectric material 3 to form a winding layer 1, such that the winding layer 1 has smaller width than the width W of the coil (it does not reach the opposite end of the coil) and thereby forming a partial winding layer 1; conducting the winding wire 2 to the opposite edge of the coil throughout the remaining part of the coil; placing a dielectric material 3 over the winding layer 1 and over the remaining part of the coil. After placing the dielectric material 3 over the coil surface, the first step is repeated starting from the edge of the coil to which the winding wire 2 was conducted, i.e. the opposite edge. Namely, the winding wire 2 is turned around the dielectric material 3 at most up to the point where the previous winding layer 1 reached, and from that point the winding wire 2 is conducted to the edge of the coil. Again, the dielectric material 3 is provided over the winding layer 1 and over the part of the coil lacking winding layer 1. Said steps are repeated until the required number of winding layers 1 is reached. The subsequent winding layers 1 should be arranged such that they do not overlap in order to avoid bulging of the coil surface. The last step of placing the dielectric material 3 over the winding layer 1 may be performed the same number of times than the steps of winding a layer of winding wire 2 on a dielectric material 3 and conducting the winding wire 2 to the opposite edge of the coil, thereby forming an arrangement where the outermost winding layer 1 is covered with dielectric material 3. The last step of placing the dielectric material 3 over the winding layer 1 may also be performed one time less than said previous steps, thereby forming an arrangement where the outermost winding layer 1 is uncovered (not covered with dielectric material 3). In that latter case, obviously, the step of conducting the winding wire 2 to the opposite edge of the coil may also be performed one time less than the step of winding a layer of winding wire 2, resulting in an arrangement shown in FIGS. 2-6.

The method allows providing a gap 4 between the winding layers 1, as described above with reference to the coil structure. In such case, the method comprises the steps of winding a layer of winding wire 2 on a dielectric material 3 to form a winding layer 1, such that the winding layer 1 does not reach the opposite end of the coil and thereby forming a partial winding layer 1; conducting the winding wire 2 to the opposite edge of the coil; placing a dielectric material 3 over the winding layer 1 and over the remaining part of the coil. After placing the dielectric material 3 over the coil surface, the winding wire 2 is turned around the coil to form another winding layer 1, whereby this winding layer 1 is finished before the end of the previous winding layer 1 is reached, leaving a gap 4 between them, and the winding wire 2 is again conducted to the edge of the coil. Again, the dielectric material 3 is provided over the winding layer and over the part of the coil lacking winding layer 1. Said steps are repeated until the required number of winding layers 1 is reached. The distance between the closest turns of the adjacent winding layers 1, starting from the opposite edges, defines the gap 4.

The dielectric material 3 may be provided over the entire surface of the coil, including the gap 4. Alternatively, the dielectric material 3 is provided only at the areas of the winding layers 1, thereby leaving the gap 4 empty.

The method may include providing various number of turns n per winding layer 1. In one example, it may include providing equal number of turns n in each winding layer 1. In another example, it may include providing different number of turns n in winding layers 1, as described with reference to FIGS. 4 and 5. The number of turns may be different in adjacent layers 1 arranged oppositely to each other (starting from the opposite sides of the coil) and/or in subsequent layers 1 arranged one over another (starting from the same sides of the coil).

In another aspect the present invention discloses an inductive device comprising a coil according to the present invention. The inductive device may be for example a transformer or a choke.

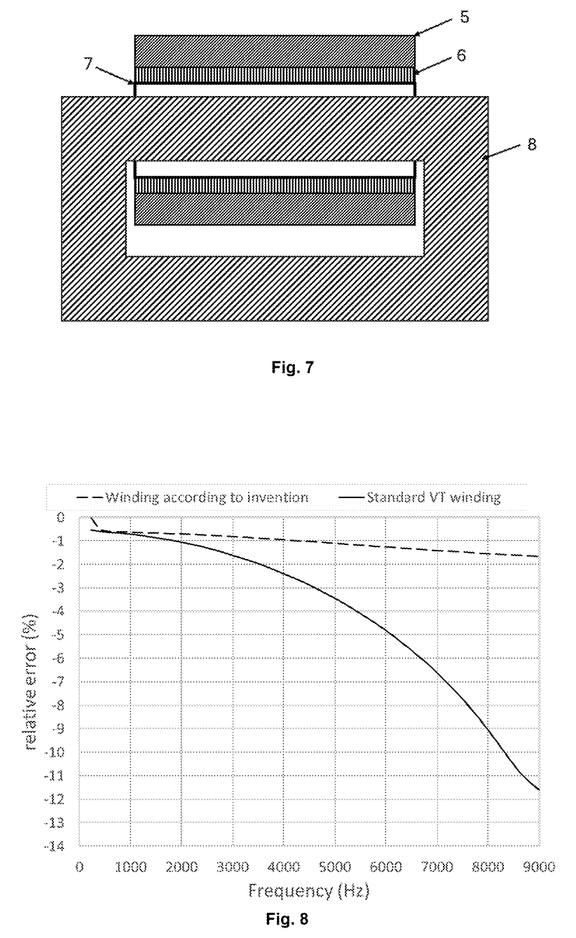

FIG. 7 depicts a transformer comprising at least two coils and a bobbin 7 placed inside of the at least two coils, where these coils are a primary coil 5 and a secondary coil 6. The primary coil 5 is a coil according to the present invention. The bobbin 7 is mounted on a core 8. The coils 5, 6 may be placed within a dielectric cast, made for example from dielectric material. Material should have sufficient dielectric strength. In one embodiment, the transformer is a medium voltage transformer. The transformer, during casting process, may be embedded in epoxy resin. In the embodiments in which the gap 4 is provided, the epoxy fills the gap 4 between the winding layers 1.

In case where the inductive device is a choke, it comprises a coil according to the invention and a dielectric cast such as epoxy or plastic casing.

FIG. 8 shows comparison of error curves for a standard VT winding (solid line) and the partial layer winding according to the invention (dashed line). Both VTs have the same bobbin and number of turns. In case of the standard winding, the secondary voltage (measured value) decreases with increasing frequency when approaching the first internal winding resonance. This internal winding resonance is strictly related with the winding natural resonance. Increasing the natural frequency of the winding also increases the frequency of the first internal winding resonance which is pronounced by lower negative amplitude error values in case of the winding according to the disclosure.

Preferably, the winding layers are separated by a gap. Preferably, the dielectric material covers the areas above and below the winding layers and the area of the gap. Alternatively, the dielectric material covers only the areas above and below the winding layers, thereby leaving the gap empty.

Preferably, the second ends of winding layers reach at most half of the width of the coil. Preferably, the winding layers have the same number of turns. Alternatively, at least two winding layers have different number of turns.

Preferably, the winding layers placed at one side of the coil have greater width than the winding layers placed at the opposite side of the coil. Preferably, the second ends of winding layers placed at one side of the coil reach beyond half of the width of the coil. Preferably, the winding layers placed one over another have decreasing number of turns.

The invention also discloses method of winding a coil described above, comprising the steps of: a) winding a layer of winding wire on a dielectric material to form a winding layer, starting from one edge of the coil, such that the winding layer has smaller width than the coil width, wherein the winding layer comprises a first end and a second end, wherein the first end of the winding layer is essentially a first edge of the coil, and the second end of the winding layer ends between the first edge and a second edge of the coil and wherein the second end of the winding layer is facing toward the second end of the coil; b) conducting the winding wire from the second end of the winding layer toward the opposite edge of the coil and connecting the winding wire to the first end of the subsequent winding layer; c) placing the dielectric material over the surface of the coil, including the winding layer and the remaining part of the coil; wherein step a) is performed at least twice, and steps b) and c) are performed at least once, and wherein step a) is repeated alternately from the opposite edges of the coil.

When steps b) and c) are performed the same number of times as step a), the outermost winding layer is covered by the dielectric material. When step c), or steps b) and c), are performed once less than step a), the outermost winding layer is not covered by the dielectric material.

Preferably, the second end of one winding layer is provided up to the point where the second end of the preceding winding layer is placed, such that the subsequent winding layers do not overlap each other, preferably leaving a gap between them. Preferably, in step c) the dielectric material is placed only in the areas above and below the winding layers. Preferably, the winding layers are provided with different numbers of turns.

The disclosure also describes an inductive device comprising a coil described above, a bobbin and an insulative casing. The indictive device may be for example a transformer or a choke.

Advantages of the embodiments in accordance with the disclosure are described hereinafter. The present disclosure allows to significantly decrease both the inductance and the capacitance of the winding coil structure, designed for inductive devices such as medium voltage transformers. Therefore, the present disclosure allows to maximize the resonant frequency of the primary winding coil structure, thereby ensuring accurate performance of voltage transformers, which cover a frequency range up to 20 kHz, or even above 20 kHz. The present disclosure ensures that desired inductance level is achieved, without necessitating an excessive number of turns or layers. Therefore, it allows not only for reducing the capacitance, but also for maintaining a compact and efficient transformer design. The proposed invention can be practically implemented using standard manufacturing processes without increasing complexity. As less winding wire is used, the manufacturing cost is reduced.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### LIST OF REFERENCE SIGNS

1 – winding layer
2 – winding wire
3 – dielectric material
4 – gap
5 – primary coil
6 – secondary coil
7 – bobbin
8 - core

What is claimed is:

1. A coil suitable for use in an inductive device, comprising:
at least two winding layers of a winding wire;
at least two layers of dielectric material, wherein each of the at least two winding layers is placed on at least one layer of the dielectric material;
wherein each of the at least two winding layers has a width smaller than a coil width, such that the winding layer occupies only a part of a coil surface;
wherein the winding layer comprises a first end and a second end, wherein the first end of the winding layer is essentially a first edge of the coil, and the second end of the winding layer ends between the first edge and a second edge of the coil and wherein the second end of the winding layer faces toward the second edge of the coil;
wherein at the second end of the winding layer, the winding wire extends toward the second edge of the coil and connects to the first end of the subsequent winding layer; and
wherein the winding layers start alternately from the opposite edges of the coil.

2. The coil according to claim 1, wherein the winding layers are separated by a gap.

3. The coil according to claim 2, wherein the dielectric material covers areas above and below the winding layers and an area of the gap.

4. The coil according to claim 2, wherein the dielectric material covers only areas above and below the winding layers, thereby leaving the gap empty.

5. The coil according to claim 1, wherein the second ends of winding layers reach at most half of the width of the coil.

6. The coil according to claim 1, wherein the winding layers have a same number of turns.

7. The coil according to claim 1, wherein at least two winding layers have a different number of turns.

8. The coil according to claim 7, wherein the winding layers placed at one side of the coil have greater width than the winding layers placed at the opposite side of the coil.

9. The coil according to claim 7, wherein the second ends of winding layers placed at one side of the coil reach beyond half of the coil width.

10. The coil according to claim 7, wherein the winding layers placed one over another have decreasing number of turns.

11. A method of winding a coil, comprising:
a) winding a layer of winding wire on a dielectric material to form a winding layer, starting from one edge of the coil, such that the winding layer has smaller width than a coil width, wherein the winding layer 1) comprises a first end and a second end, wherein the first end of the winding layer is a first edge of the coil, and the second end of the winding layer ends between the first edge and a second edge of the coil, and wherein the second end of the winding layer is facing toward the second end of the coil;
b) conducting the winding wire from the second end of the winding layer toward an opposite edge of the coil and connecting the winding wire to the first end of a subsequent winding layer;
c) placing the dielectric material over a surface of the coil;
wherein step a) is performed at least twice, and steps b) and c) are performed at least once, and wherein step a) is repeated alternately from the opposite edges of the coil.

12. The method according to claim 11, wherein the second end of one winding layer is provided up to the point where the second end of the preceding winding layer is placed, such that the subsequent winding layers do not overlap each other, preferably leaving a gap between them.

13. The method according to claim 12, wherein in step c) the dielectric material 3) is placed only on the areas above and below the winding layers.

14. The method according to claim 11, wherein the winding layers are provided with different number of turns.
